(19) United States
(12) Patent Application Publication
(10) Pub. No.: US 2009/0067093 A1
(43) Pub. Date: Mar. 12, 2009

(54) Perpendicular Magnetic Recording Medium and Magnetic Recording Apparatus

(76) Inventors: Chiseki Haginoya, Tokyo (JP); Yuko Tsuchiya, Tokorozawa (JP); Hisako Takei, Nishitokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/185,845

(22) Filed: Aug. 5, 2008

(30) Foreign Application Priority Data
Sep. 7, 2007 (JP) 2007-233090

(51) Int. Cl. G11B 5/60; G11B 5/82; B44C 1/22; B05D 5/12

(52) U.S. Cl. 360/234.3; 360/135; 216/22; 427/130; 264/293; G9B/5.293; G9B/5.229

(57) ABSTRACT

A discrete track medium and a bit patterned medium with a high SNR are manufactured at low cost. A seed layer and a recoding layer are formed on a bottom surface and a side wall of a groove portion, which is formed between non-magnetic projected structures artificially patterned. Then, the recording layer on the projected portion is removed.

### CLAIM OF PRIORITY

The present application claims priority from Japanese application JP 2007-233090 filed on Sep. 7, 2007, the content of which is hereby incorporated by reference into this application.

### BACKGROUND OF THE INVENTION

1. Field of the Invention

The present invention relates to a perpendicular magnetic recording medium and a magnetic recording apparatus incorporating the perpendicular magnetic recording medium.

2. Description of the Related Art

Improvement in recoding density in a magnetic recording apparatus has been demanded. For this end, in place of the conventionally-used in-plane recording medium, a so-called perpendicular recording medium has been widely studied. In this perpendicular recording medium, a magnetization direction of a recording film is perpendicular to a disk surface. In the perpendicular recording medium, a hard magnetic material, which has magnetic anisotropy in a direction perpendicular to a disk substrate, is used for a recording layer, and information is recorded by relating the information to an upward or to a downward direction of the magnetization. It is considered that, as compared with the in-plane recoding system in which magnetization is reversed in a disk plane, this perpendicular recording system is suitable for stable, high-density recording particularly when the size of bits is small. This is because a magnetic flux generated from recording bits forms a closed magnetic path through a bit upper portion and a bit lower portion.

As to the foregoing perpendicular recording system, attention has been paid to, particularly, a system which uses: a recording head with a structure called a single pole type (SPT) head; and a recoding medium (perpendicular two-layer medium) including a recording layer composed of a soft magnetic underlayer (SUL) and a hard magnetic material which are formed on a smooth disk substrate. In this system, a magnetic flux from a primary magnetic pole distal end of the SPT head reaches the SUL while passing through the recording layer. It is configured so that the magnetic flux spreads in the SUL and again returns through a sub magnetic pole. Combination of the SPT head and the perpendicular magnetic recording medium including the SUL makes it possible to effectively increase a recording magnetic field and a magnetic field gradient in the recording layer.

In recent years, there have been proposed magnetic recording media in which recording tracks are artificially patterned (discrete track media (DTM)), magnetic recording media in which recoding bits are patterned (patterned media (PM)), bit patterned media (BPM) or discrete bit media (DBM). Along with improvement in recording density, BPM and DTM are required to reduce the sizes of its bits or its tracks. For manufacturing such a fine structure, techniques such as electron beam lithography (EBL) and X-ray lithography are used. Moreover, there has been reported on formation of fine patterns by an imprinting method to reduce costs.

Manufacturing of DTM by using these techniques is described in, for example, Wachenschwanz et al, IEEE Trans. Magn.41 (2004) p. 670. In a system proposed by this document, a magnetic recording layer is grown on uneven structure of a non-magnetic material, and recording and reproducing are performed on the recording layer on the projected portion. When the medium is installed in a hard disk drive (HDD), at the time of recording and reproducing, a difference occurs between a distance from the recording and reproducing head to the magnetic material on the projected portion and a distance from the recording and reproducing head to the magnetic material on the recessed portion. The difference is substantially equal to a level difference between the recessed and projected portions on a substrate. It is a DTM of substrate processing type that aims to improve magnetic separation by using the difference in the distance from the recording and reproducing head. Although fabrication process is easy, this system has a problem that magnetic films are connected on the recessed and projected portions, thus making it difficult to obtain sufficient magnetic separation. On the other hand, in a system proposed by Hattori et al, IEEE Trans. Magn.40 (2004) p. 2510, a resist pattern is formed on a flat magnetic recording layer, and the resist pattern is used as a mask to cut off the magnetic recording layer by using a method such as ion beam etching (IBE) and reactive ion etching (RIE). The magnetic separation between tracks is achieved by physically cutting off the flat magnetic recording layer in this way. However, there is a possibility that deterioration of magnetic characteristics occurs due to damages caused by IBE and RIE performed at the time of processing the magnetic recording layer. This may deteriorate recording and reproducing characteristics of a drive which uses this medium.

In order to avoid the aforementioned problems, in a system described in Japanese Patent Application Publication No. 2004-227639, a SUL containing polymer is heated, and a stamper shape is transferred thereto. Thereafter a recording layer is grown in the structure thus formed. In a system disclosed in Japanese Patent Application Publication No. 2005-71467, a glass substrate is heated up to a softening point, and a stamper shape is transferred thereto. Thereafter a magnetic film is formed, and the film is planarized by polishing. Moreover, in a system disclosed in Japanese Patent Application Publication No. 2003-178431, a thermoplastic material is molded by using a stamper, and the resultant mold is buried in a magnetic recording layer.

### SUMMARY OF THE INVENTION

Regarding the medium in which the recording layer is grown in the stamper shape transferred to the SUL, in the completed magnetic recording medium, the SUL is exposed to the entire regions other than the recording bits on the uppermost surface. Because of this configuration, a magnetic flux from a recording head is absorbed by the SUL when a recording operation is performed, so that recording cannot be effectively performed. Moreover, there is a possibility that an uneven structure formed by a heated stamper breaks by a temperature rise caused at the time of storage in a HDD is stored and at the time of recoding and reproducing operations. Accordingly, a problem may arise in view of reliability. In a system in which a SUL is formed on a material that is softened by heating, there is a problem that a SUL structure is disordered when the shape of the stamper is transferred. Further, this causes difficulty in the process of transferring the shape to a soften layer under the SUL by heating. Further, in a system in which a magnetic recording layer is buried in a thermoplastic material, there is a possibility that deformation in shape or the like occurs by a temperature rise caused at the time of storage in a HDD and at the time of recoding and reproducing operations. Moreover, it is known that a base layer is invariably left when the shape of the stamper is transferred. A base layer thickness may be reduced based on the transfer condition, but it is difficult to reduce a distribution of the base layer thickness over the entire surface of the disk. Variation in the base layer thickness changes a distance from a SPT head to a SUL, and therefore the magnitude of the recording magnetic field which is experienced by each recording bit is effectively varied. If a base layer removing step is carried out, ion, plasma and like are directly exposed to the SUL, thus causing the deterioration of the magnetic characteristics of SUL. In the aforementioned known examples, it is illustrated that the magnetic recording layer is grown on only the recessed and projected portions to be parallel to the substrate. Such growth may be possible by controlling the direction of sputtered particles, but it is impractical to remove all sputtered particles having velocity in an in-plane direction in terms of mass productivity.

The present invention provides a practical processing medium that simultaneously solves both deterioration of magnetic characteristics and a reduction in throughput caused at the time of processing, in processing media such as DTM and BPM.

In the present invention, a magnetic recording layer is grown between projected portions of an uneven structure formed of a non-magnetic material, with a seed layer interposed in between, and a crystal structure of the magnetic recording layer is controlled by the seed layer. In other words, a perpendicular magnetic recording medium of the present invention includes a non-magnetic layer having a recessed portion and a magnetic recording layer formed on a bottom surface and a side wall of the recessed portion with a seed layer interposed in between, and the magnetic recoding layer is placed in the recessed portion. Moreover, a soft magnetic underlayer is formed under the seed layer on the recessed portion or under a non-magnetic layer having the recessed portion.

According to the present invention, it is possible to provide a magnetic recoding medium in which noise between recording tracks or between recording bits is suppressed. Furthermore, it is possible to manufacture the magnetic recording medium with high throughput and at low cost.

### BRIEF DESCRIPTION OF THE DRAWINGS

FIG. 1 is a step schematic view exemplary showing an example of a manufacturing process of a magnetic recording medium according to the present invention.

FIG. 2 is an exemplarity cross section schematic view of a medium according to the present invention.

FIG. 3A is an exemplarity schematic view of an upper surface of a DTM medium according to the present invention, and FIG. 3B is an exemplarity schematic view, which is a cross-sectional bird's-eye view in a track traverse direction.

FIG. 4A is an exemplarity schematic view of an upper surface of a BPM medium according to the present invention, and FIG. 4B is an exemplarity schematic view, which is a cross-sectional bird's-eye view in a track traverse direction.

FIG. 5 is a schematic view exemplary showing a cross section of an uneven structure before a seed layer and a recoding are grown by sputtering.

FIG. 6A is a schematic view exemplary showing an outline of a HDD, and FIG. 6B is a cross section schematic view of a recording medium and a head, which shows a state when the HDD is operated.

FIG. 7 is a schematic view exemplary showing another embodiment of a manufacturing process of a magnetic recording medium according to the present invention.

FIG. 8 is a schematic view exemplary showing still another embodiment of a manufacturing process of a magnetic recording medium according to the present invention.

### DESCRIPTION OF THE PREFERRED EMBODIMENTS

Hereinbelow, an embodiment of the present invention will be described with reference to the drawings.

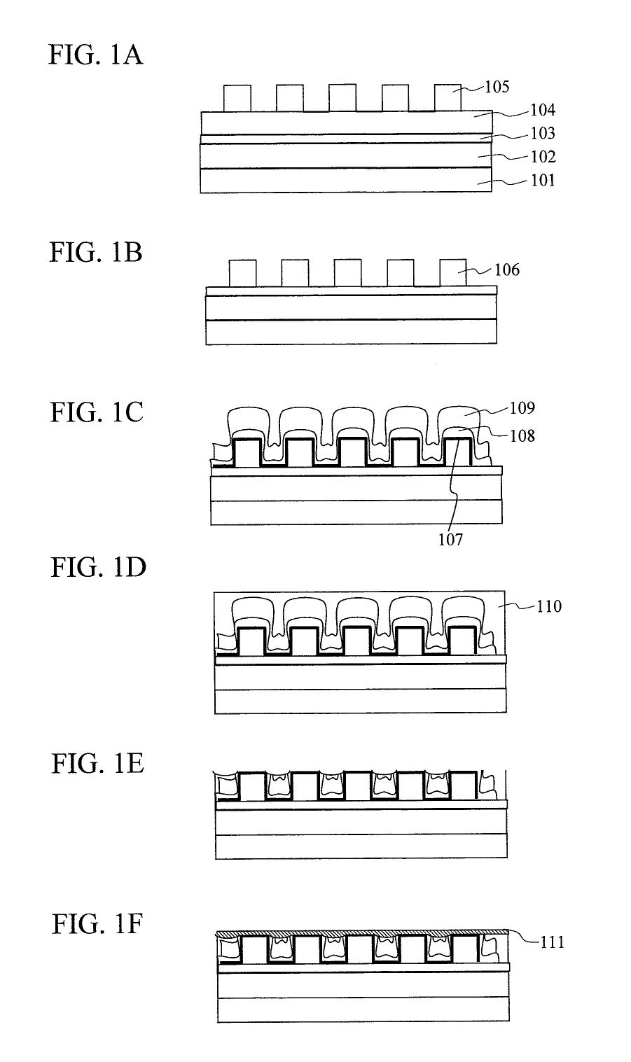

FIG. 1 is a schematic flow chart exemplary showing an example of a manufacturing process of a magnetic recording medium according to the present invention. DTM is assumed in the drawing, which shows a cross section schematic view in a track direction. The same manufacturing process may be applied to BPM, as well.

A substrate 101 is carried into a vacuum chamber of a sputtering apparatus, and the following film forming process is carried out. As shown in FIG. 1A, an SUL 102 is grown on the substrate 101. Here, the substrate 101 is formed of a tempered glass having a thickness of 0.635 mm, and the SUL is formed of a soft magnetic material containing Co. Although not shown in the drawing, necessary layers such as an adhesion layer are grown between the substrate 101 and the SUL 102. A protective layer 103 is grown on the SUL 102. In this embodiment, Pt having a thickness of 2 nm is used as the protective layer 103, but other materials, such as Ta, W, and NiTi, may also be used. In order to reduce a distance between a SPT and a SUL at the time of a HDD installation, the thickness of the protective layer 103 is desirably as thin as possible. However, a value of the thickness of the protective layer 103 must be appropriately selected in consideration of a later-described RIE condition for the purpose of protecting the SUL from the later-described RIE process damage. Moreover, a condition selected here is that a thickness distribution of the protective layer 103 is suppressed within 5% or less of the entire surface of the substrate 101.

A non-magnetic material 104 is grown on the protective layer 103. In this embodiment, SiO₂ is used as the non-magnetic material 104. Alternatively, other materials such as SiN, Al₂O₃ may also be used. It is desirable that the thickness of the non-magnetic material 104 should be equal to or more than the depth of a later-described uneven structure. Moreover, the non-magnetic layers 104 may be formed of a single layer or multiple layers. If the non-magnetic layers 104 is formed of multiple layers in which one having a low etching rate, such as Pi, Ta, W, NiTi, is formed as an upper layer, this upper layer may be used as a mask for etching of a lower layer of the non-magnetic material 104.

Next, the sample is taken out of the sputtering apparatus, and a resist is applied on the surface thereof. A necessary track, a servo pattern and an alignment mark used at the time of a drive installation are formed on the resist by EBL (Electron Beam Lithography). In this embodiment, a resist pattern 105, having a track pitch (Tp) of 100 nm at a central portion of a disk, is formed. Here, EBL is used for fine pattern formation. Alternatively, it is, of course, possible to use methods such as EUV lithography, X-ray lithography, and imprinting. If imprinting is used, a base layer removing step is carried out as required.

Next, as shown in FIG. 1B, with the resist pattern 105 formed by the above method used as a mask, a pattern is transferred on the non-magnetic material 104 by using RIE or ion milling. If the non-magnetic material 104 is formed of a plurality of layers, upper layers may be patterned by ion milling, and with the resultant pattern used as a mask, lower layers may be patterned by using RIE. In this way, a non-magnetic uneven structure 106 having such a pattern is obtained. It is desirable that the depth of the uneven structure should be equal to or more than a thickness obtained by adding the respective depths of a later-described seed layer 108 and a recording layer 109. Moreover, cleaning is carried out as required to remove a foreign matter.

Sequentially, as shown in FIG. 1C, a stop layer 107 is grown on the uneven structure 106. The stop layer 107 is used to stop etching carried out in a later-described step. Here, a diamond-like carbon (DLC) having a thickness of 2 nm is used for the stop layer 107. In consideration of a selection ratio which is determined by a balance between a material and an etching process for a planarization layer 110 to be grown in a next step, a material such as Pi, Ta, W, and NiTi, whose etching rate is lower than that of the planarization layer 110, may be used in place of DLC. Next, the seed layer 108 is grown on the stop layer 107. The seed layer 108 is a layer for controlling the crystallinity of the recording layer 109. In this embodiment, the thickness of the seed layer is set to 15 nm. Sequentially, the recording layer 109 is grown. The recording layer may be formed of a single or multiple layers. In this embodiment, the recording layer 109 is formed of CoCrPt and CoCrPt containing SiO₂, and a thickness obtained by adding both is 20 nm. In other words, a thickness obtained by adding the seed layer 108 and the recording layer 109 is 35 nm. Accordingly, as mentioned above, it is desirable that the depth of the uneven structure formed on the non-magnetic layer 104 should be equal to or more than 35 nm.

After the formation of the magnetic recording layer, the planarization layer 110 is formed as shown in FIG. 1D. A non-magnetic material is required as a material for the planarization layer. In this embodiment, a SiO₂ layer is formed by sputtering. A material such as SiN and Al₂O₃ may be used in place of SiO₂. Further, it is also possible to use a material obtained by spin-coating and curing a SOG (Spin On Glass) or the like in place of sputtering.

After the formation of the planarization layer 110, planarization is carried out as shown in FIG. 1E. In this embodiment, etch back using ion milling is employed as a method for the planarization. Here, the substrate is etched back as being rotated in parallel with its substrate surface, where an angle of an ion incident direction to the substrate surface is about 15°. In this step, at first, the planarization layer 110 and the recording layer 109 are cut in parallel with the disk surface by the oblique incidence and an effect of substrate rotation. A cutting region moves down with the progress of the steps. Since the stop layer 107 is formed of a material having a low etching rate, ion milling is substantially stopped in a region where the stop layer 107 appears on the surface. Ion milling is performed until the stop layer 107 appears on the entire surface of the disk, and the planarization is thus completed. In addition, if a secondary ion mass spectrometer or the like is installed in an ion milling apparatus, it is possible to detect that the planarization is almost completed when the stop layer material is detected. Note that it is desirable that ion milling be performed for another certain period of time after the detection of the stop layer material in order to ensure completion of the planarization of the entire disk surface. Further, in this process, chemical mechanical polishing (CMP) or the like may alternatively be used in place of ion milling. In this case, the planarization step is stopped by the stop layer 107 on a projected portion, and therefore the recording layer 109 buried in groove portions is not cut. After the planarization step, the stop layer 107 remains on at least part of the medium. After the planarization process, a carbon protective layer and a lubricating layer 111 are grown to thereby complete a magnetic recoding medium as shown in FIG. 1F.

A track region of the completed magnetic recording medium was observed by using a transmission electron microscope (TEM). According to a TEM image, it was confirmed that the seed layer 108 and the recoding layer 109 were grown on a recessed portion of the uneven structure 106. Moreover, it was confirmed that the recording layer 109 was grown while maintaining an orientation of the seed layer 108 and that the recording layer 109 grown on the recessed portion had crystallinity in a direction perpendicular to the substrate surface. Further, it was confirmed that the recording layer 109 on a side wall portion had crystallinity in a direction substantially perpendicular to the side wall, reflecting the orientation of the seed layer 108. Moreover, it was confirmed that the thickness of the recoding layer 109 on the side wall portion was smaller than that of the recording layer 109 on the recessed portion, reflecting a throwing power during the sputtering process. Furthermore, a distance between the lowermost surface of the recording layer 109 and the SUL 102 corresponds to the total thickness of the seed layer 108 and the protective layer 103. In this embodiment, the thickness was 17 nm. This distance may be, of course, reduced by reducing the thicknesses of the seed layer 108 and the protective layer 103 with consideration given to the magnetic recording property.

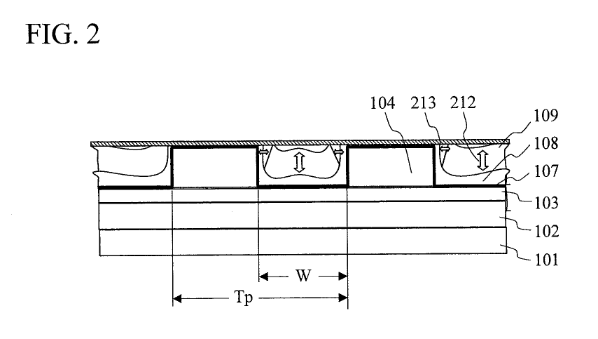

FIG. 2 is a schematic view exemplary showing an enlarged cross section of a medium manufactured by the method of the aforementioned embodiment. The SUL 102 and the protective layer 103 are grown on the substrate 101. In addition, although not shown in the drawing, necessary layers such as an adhesion layer are formed between the substrate 101 and the SUL 102. The protective layer 103 was formed to protect the SUL 102 at the time of processing the projected and recessed portions of the non-magnetic material 104. However, as a result of observation of the cross section, a reduction in the thickness of the protective layer 103 was not confirmed. It should be noted, however, that there is a case in which the thickness of the protective layer 103 is reduced depending on the processing process. Even in this case, since the protective layer is left, even slightly, on the SUL 102, the SUL 102 is protected from damage caused by etching or milling.

The stop layer 107 is grown on the uneven structure of the non-magnetic material 104. The protective layer and the lubricating layer are formed on the projected portions of the stop layer 107. Moreover, the seed layer 108 and the recording layer 109 are grown on the recessed portions of the stop layer 107. The recording layer 109 is crystal-grown in a direction perpendicular to the substrate surface and has a magnetic anisotropy as shown by an arrow 212 in the drawing. The seed layer 108 and the recording layer 109 are grown on the side wall. It should be noted that there is no problem even though the stop layer 107 on the side wall cannot be confirmed due to its small thickness. The recording layer 109 on the side wall is crystal-grown, reflecting the orientation of the seed layer 108 on the side wall. As a result, an axis of the magnetic anisotropy is substantially parallel to the substrate wall as shown by an arrow 213 in the drawing.

Moreover, although the thickness of the recording layer 109 on the side wall surface is smaller than that of the recording layer 109 in the recessed portion, the value is not zero. This indicates that the incident direction of sputtering particles is partially inclined from the direction perpendicular to the substrate in the formation process of the recording layer 109. This is a result in which the obliquely incident particles are allowed to be grown on the side wall surface in order to achieve high throughput of the medium manufacturing. In the present embodiment, however, the seed layer has a crystal orientation on the side wall surface, and therefore anisotropy of the recording layer is substantially parallel to the substrate, and no influence is exerted on the recording and reproducing operations using a perpendicular recording head.

Moreover, in the embodiment described below, a distance between the centers of a certain projected portion and a recessed portion adjacent thereto, of the uneven structure shown in FIG. 2 is defined as a track pitch Tp and a width of a recessed portion of the non-magnetic material 104 is defined as a track width W.

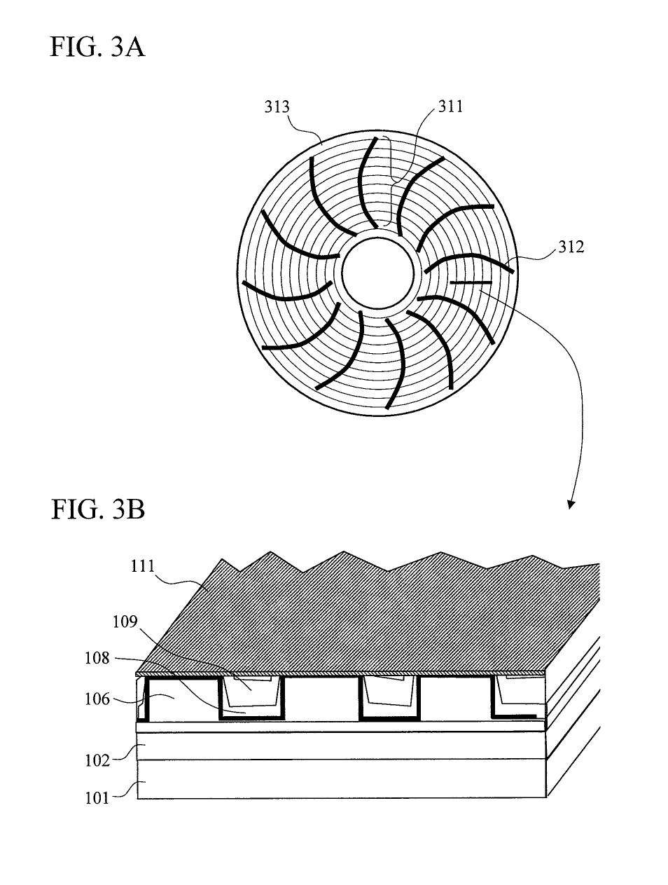

FIG. 3A is a schematic view of an upper surface of the magnetic recording medium of this embodiment, and FIG. 3B is a schematic view, which is a cross-sectional bird's-eye view in a track traverse direction. In FIG. 3A, a track 311 and a servo pattern 312 are formed on a disk 313 by the aforementioned method. Although the servo pattern is not shown due to its small size, an outline of the position is shown in FIG. 3A. In this embodiment, a track pitch in the vicinity of a central portion of the disk is 100 nm. This value may be changed according to the radial position on the disk. As shown in FIG. 3B, the flat SUL 102 and the non-magnetic material 106 having an uneven structure are formed on the glass substrate 101. The seed layer 108 and the recording layer 109 are formed on the groove portions of the non-magnetic material 106 having the uneven structure. Here, a crystal axis of the recording layer 109 on the bottom surface of the groove portion is oriented in a direction perpendicular to the substrate surface. Moreover, the crystal axis of the recording layer 109 on the side wall of the groove portion is oriented in a direction substantially horizontal to the substrate surface. The uppermost surface is planarized, and the protective film and the lubricating film 111 are formed thereon.

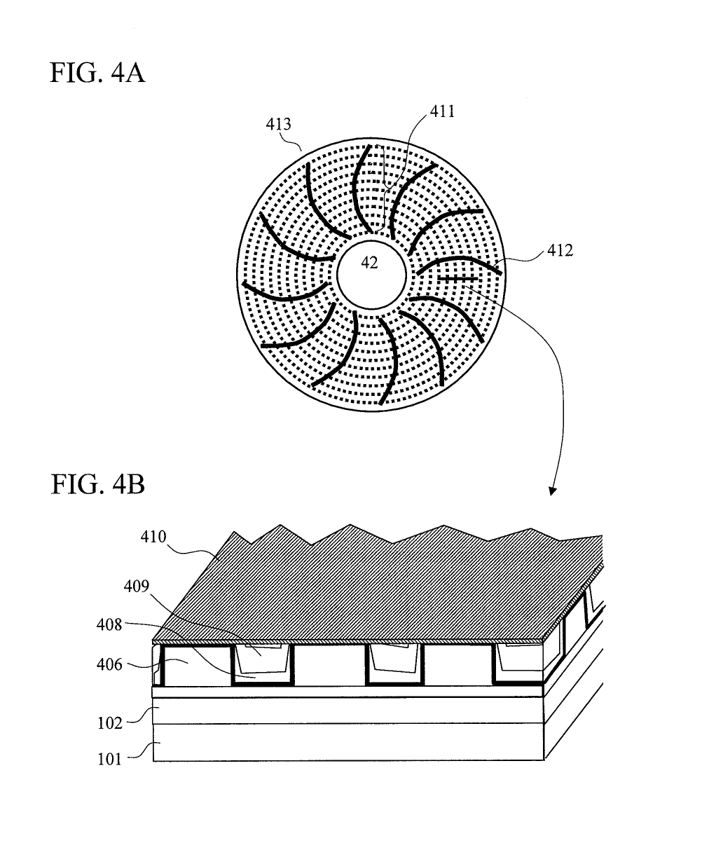

FIG. 4A is a schematic view of an upper surface of BPM manufactured using the process explained in FIG. 1, and FIG. 4B is a schematic view, which is a cross-sectional bird's-eye view in a track traverse direction. In FIG. 4A, a bit 411 and a servo pattern 412 are formed on a disk 413 by the aforementioned method. In this embodiment, a track pitch in the vicinity of a central portion of the disk is 50 nm, and a pitch cycle is 25 nm. These values may be changed according to the radial position on the disk. As shown in FIG. 4B, the flat SUL 102 and a non-magnetic material 406 having an uneven structure are formed on the glass substrate 101. A seed layer 408 and a recording layer 409 are formed on groove portions of the non-magnetic material 406 having the uneven structure. Here, a crystal axis of the recording layer 409 on the bottom surface of the groove portion is oriented in a direction perpendicular to the substrate surface. Moreover, the crystal axis of the recording layer 409 on the side wall of the groove portion is oriented in a direction substantially horizontal to the substrate surface. The uppermost surface is planarized, and a protective film and a lubricating film 410 are formed thereon.

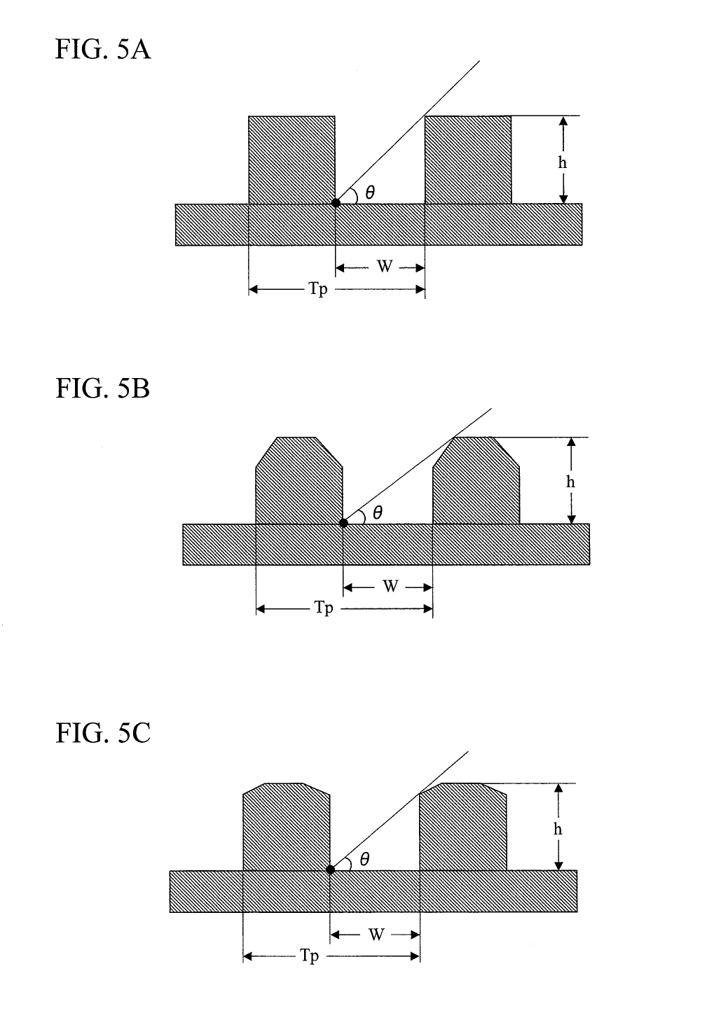

FIG. 5 is a schematic view showing a cross section of an uneven structure before a seed layer and a recoding are grown by sputtering. In FIG. 5A, Tp denotes a track pitch, W denotes a groove width, and h denotes a groove depth. Hereinafter, the incident direction of sputtering particles will be described. Assume a case where the recessed and projected portions have a cross-sectional rectangular shape. In such a case, when a particle enters the substrate surface in a state where an incident angle φ of a sputtering particle is larger than an angle θ formed by the uneven structure, where θ=arctan(h/w) (namely, φ≧θ), the particle may reach the bottom surface of the recessed portion. On the other hand, a particle having an incident angle φ smaller than θ cannot reach the bottom surface of the recessed portion.

Normally, the value of incident angle φ has a certain distribution range based on a target-sample distance (TS distance), sputtering gas pressure, applied voltage, plasma conditions and the like. Generally, in order to increase the incident angle φ when the relevant layer is grown by sputtering, an increase in the sample and the sputtering target (TS) distance and insertion of a collimator therebetween are effective. When the incident angles φ of all sputtering particles are 90°, the sputtering particles reach the substrate which serving as parallel beams. Sputtering by parallel beams has an effect of reducing adhesion of particles to the side wall portion. At the same time, such sputtering shields particles having velocity in a direction parallel to the substrate surface, so that the growth rate is reduced. This results in a decrease in throughput at the time of mass-production.

In this embodiment, taking into consideration the mass-production and the magnetic characteristics, a central value in the distribution of the incident angle φ is made lager than θ. This makes it possible to grow numerous particles on the recessed portion without reducing the throughput, unlike the case of obtaining a complete parallel beam of θ=90°.

Here, in a case where the projected portion is not formed with a single angle, θ must be decided by selecting a vertex as shown in FIGS. 5B and 5C. In a case where the projected portion is formed by an arc or the like, θ is defined by a tangent to the curve

Forming the magnetic recording medium by the method explained in this embodiment makes it possible to manufacture the magnetic recording medium with high throughput in which the recoding tracks or recording bits are magnetically separated from each other and in which the perpendicular magnetic anisotropy of the recording layer in each region is good. Use of the magnetic recording medium thus manufactured and installed in the hard disk drive makes it possible to improve the track pitch because the magnetic flux entering the reproducing head from the adjacent track at the time of reproduction is reduced as compared with a case in which continuous media are used. Accordingly, high density recording and producing may be performed. Moreover, as compared with DTM of the so-called substrate-processing type and magnetic film processing type shown in the conventional techniques, the present embodiment may provide inexpensive recording media having excellent magnetic characteristics, such as anisotropy, and high thermal fluctuation resistance. Improvement of the thermal fluctuation resistance ensures stable information recording even at the time of high density recording.

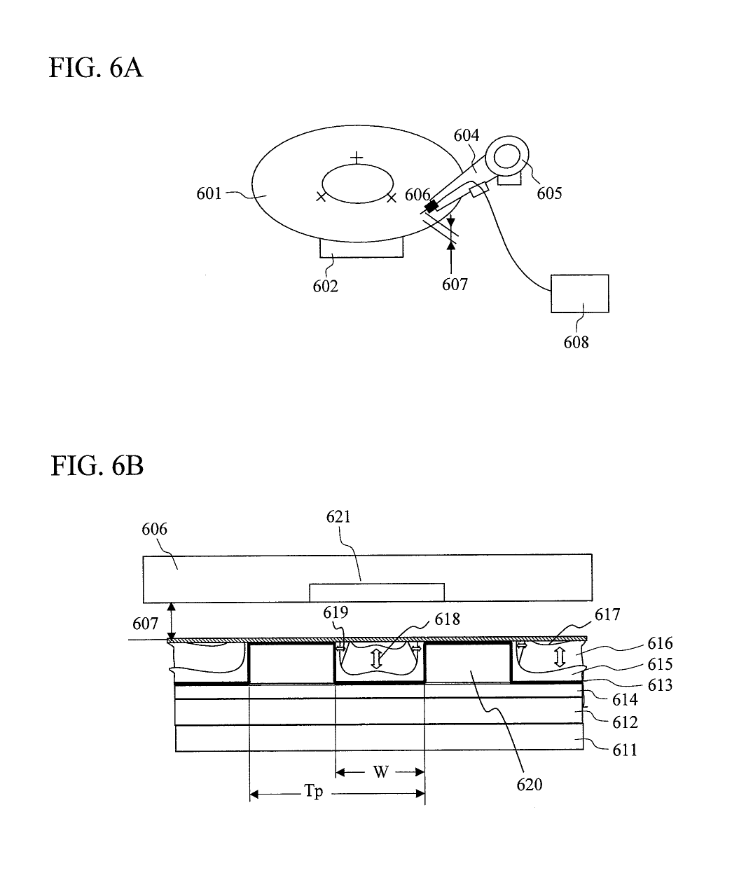

With reference to FIGS. 6A and 6B, the following will explain an example in which the magnetic recording medium of the present invention is installed in a HDD. FIG. 6A is a schematic view showing the outline of the HDD. A disk 601 manufactured according to the present example is fixed to a spindle 602 so as to rotate about a rotation axis. In an inner peripheral portion of the disk 601, there are provided alignment marks used to adjust the central axis to the spindle 602 when the disk 601 is fixed thereto. A recording and reproducing head is mounted in a slider 606 and is connected to a rotary actuator 605 through a gimbal 604. The slider 606 may be moved to a necessary location on the disk 601 by the rotary actuator 605 and by the rotation of the disk 601 caused by the spindle 602. The recording and reproducing head in the slider 606 is connected to a signal processing system 608. A necessary structure is formed on a flying surface of the slider 606, and the disk 601 and the slider 606 may be relatively moved, while maintaining a flying height 607, by an aerodynamic effect. In this embodiment, the flying height 607 is set to 7 nm by adjusting the slider groove shape and the number of rotations.

FIG. 6B is a cross section schematic view of a recording medium and a head, which shows a state when the HDD is operated. When the HDD is in a recording operation, a magnetic flux from a recording head 621 installed in the slider 606 is absorbed by a flat SUL 621. At this time, a recording layer 616 on the bottom portion of the recessed portion has strong crystal anisotropy in a direction perpendicular to the substrate surface. An arrow 618 shows a direction of the crystal anisotropy in this region. Accordingly, the magnetization of the recoding layer 616 in this region is rotated according to the direction of a recording magnetic field and is directed upward or downward. Meanwhile, as to the recording layer 616 on the side wall surface, magnetization of the recoding layer 616 on the side wall surface is directed to the recoding magnetic field at the time when the recording magnetic field is applied. However, since the direction of the crystal anisotropy is substantially horizontal, the recording magnetic field is eliminated and magnetization is returned to the horizontal direction. An arrow 619 shows a direction of the crystal anisotropy in this region. This region is extremely thin and has a small volume, and therefore a magnetization amount is also extremely small. A stop layer 613 used in the manufacturing steps is left on a protective layer 614. A planarization layer 617 used in the manufacturing steps is also left on the recording layer 616 in some cases.

Hereinafter, the reproducing operation will be described. The magnetization of the recording layer 616 grown on the bottom portion of the recessed portion is stabilized in a direction perpendicular to a substrate 611, so that a necessary sufficient magnetic flux is generated as a signal. This is because crystallinity is excellent and because direct IBE and RIE steps for physically cutting the recoding layer are not carried out in the processing process, unlike the conventional techniques. In other words, according to the present embodiment, discontinuous tracks may be formed on the recording layer 616 without receiving milling damage. Moreover, as mentioned above, the magnetization direction of the recording layer 616 on the side wall portion is controlled by a seed layer 615 and has no random property. Moreover, the recoding layer 616 on the side wall portion has a thickness smaller than that of the recoding layer 616 on the bottom portion of the recessed portion, and therefore an amount of magnetic flux to be generated is also small. Accordingly, the recoding layer 616 on the side wall portion may be neglected as a noise source. This indicates that a medium having a large signal-to-noise ratio (SNR) may be provided, compared to the discrete track medium of the magnetic field processing type conventionally proposed. Furthermore, a target track is separated from its adjacent track by a non-magnetic material 620. Since no magnetic flux is generated from the non-magnetic material 620, no noise is generated.

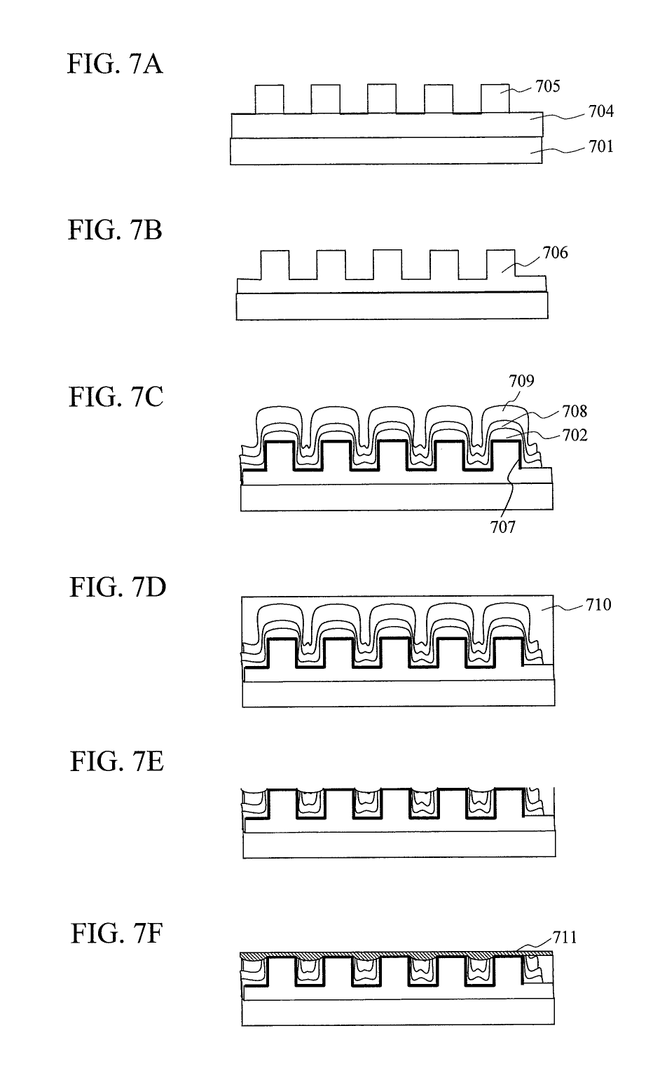

FIG. 7 is a schematic view showing another embodiment of a manufacturing process of the magnetic recording medium according to the present invention. DTM is assumed is this drawing, which shows a cross section schematic view in a track direction. However, the same manufacturing process may be applied to BPM, as well.

As shown in FIG. 7A, a non-magnetic material 704 is grown on a substrate 701. In this embodiment, SiO₂ is used as the non-magnetic material 704, but materials such as SiN and Al₂O₃ may also be used. The non-magnetic layers 704 may be formed of a single layer or multiple layers. If the non-magnetic layers 704 is formed of multiple layers in which one having a low etching rate such as Pi, Ta, W, and NiTi is formed as an upper layer, this upper layer may be used as a mask for etching of a lower layer of the non-magnetic material 704. A resist is applied on a sample surface on which the non-magnetic material 704 has been grown. A necessary track and a servo pattern 705 are formed on the resist by EBL. Although EBL is employed in this embodiment, methods such as EUV lithography, X-ray lithography, and imprinting may alternatively be employed, of course. If imprinting is employed, a base layer removing step is carried out as required.

Next, as shown in FIG. 7B, with the resist pattern 705 used as a mask, a pattern is transferred on the non-magnetic material 704 by RIE or ion milling. If the non-magnetic material 704 is formed of multiple layers, it is preferable that the upper layers be patterned by ion milling, and that the lower layers be patterned by RIE with the resultant pattern used as a mask. In this way, a non-magnetic uneven structure 706 having such a pattern is obtained. Cleaning is carried out as required to remove a foreign matter.

Sequentially, as shown in FIG. 7C, a stop layer 707 is grown on the uneven structure 706. A diamond-like carbon (DLC) having a thickness of 2 nm is used for the stop layer 707. In place of the DLC, materials such as Pi, Ta, W, and NiTi may be used as the stop layer 707. Next, the SUL 702 is grown on the stop layer 707. The SUL 702 may be formed of a single or multiple layers. Next, a seed layer 708 is grown on the SUL 702. The seed layer 708 is a layer for controlling the crystallinity of a recording layer 709. In this embodiment, the thickness of the seed layer is set to 15 nm. Sequentially, the recording layer 709 is grown. The recording layer may be formed of a single or multiple layers. In this embodiment, the recording layer is formed of CoCrPt and CoCrPt containing SiO₂, and a thickness obtained by adding both is 20 nm.

After the formation of the magnetic recording layer, a planarization layer 710 is formed as shown in FIG. 7D. A non-magnetic material is required as a material for the planarization layer. In this embodiment, a SiO₂ layer is formed by sputtering. A material such as SiN and Al₂O₃ may be used in place of SiO₂. Further, it is also possible to apply a SOG (Spin On Glass) or the like in place of sputtering.

After the formation of the planarization layer 710, planarization is carried out as shown in FIG. 7E. In this embodiment, etch back using ion milling is used for the planarization. Here, the substrate is etched back as being rotated in parallel to the substrate surface, where an angle of an ion incident direction to the substrate surface is about 5°. In this step, at first, the planarization layer 710 and the recording layer 709 are cut in parallel to the disk surface by an oblique incidence and an effect of substrate rotation. A cutting region moves down with the progress of the steps. A material having a low etching rate is used as the stop layer 707, and therefore ion milling is substantially stopped in a region where the stop layer 707 appears on the surface. The ion milling is performed until the stop layer 107 appears on the entire surface of the disk, and the planarization is thus completed. In addition, if a secondary ion mass spectrometer or the like is installed in an ion milling apparatus, it is possible to detect that the planarization is almost completed when the stop layer material is detected. Note that it is desirable that the ion milling be performed for another certain period of time after the detection of the stop layer material in order to ensure completion of the planarization of the entire disk surface. Chemical mechanical polishing (CMP) or the like may alternatively be used in place of the ion milling step. After the planarization step, a carbon protective layer and a lubricating layer 711 are grown to thereby complete a magnetic recoding medium as shown in FIG. 7F.

A track region of the completed magnetic recording medium was observed by using a transmission electron microscope (TEM). According to a TEM image, it was confirmed that the seed layer 708 and the recoding layer 709 were grown on a recessed portion of the uneven structure 706. Moreover, it was confirmed that the recording layer 709 was grown while maintaining an orientation of the seed layer 708, and that the recording layer 709 grown on the recessed portion had crystallinity in a direction perpendicular to the substrate surface. It was confirmed that the recording layer 709 on a side wall portion had crystallinity in a direction substantially perpendicular to the side wall, reflecting the orientation of the seed layer 708. Moreover, it was confirmed that the thickness of the recoding layer 709 on the side wall portion was smaller than that of the recording layer 709 on the recessed portion, reflecting a throwing power during the sputtering process.

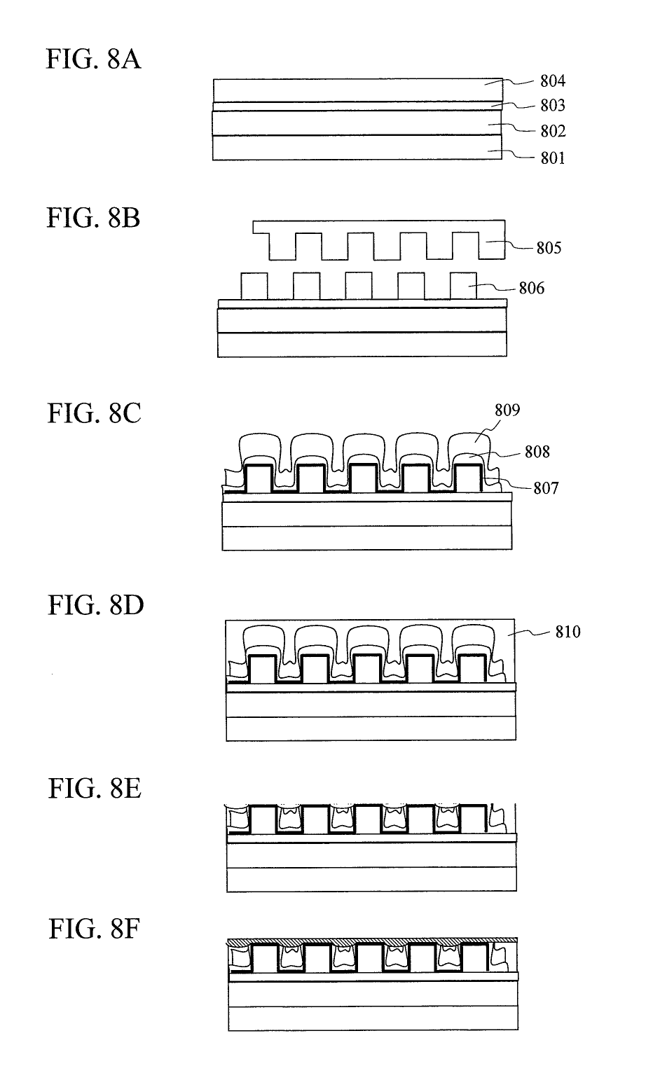

FIG. 8 is a schematic view showing still another embodiment of a manufacturing process of the magnetic recording medium according to the present invention. DTM is assumed in the drawing, which shows a cross-sectional schematic view in a cross-sectional schematic view in a track direction. The same manufacturing process may be applied to BPM.

A substrate 801 is carried into a vacuum chamber of a sputtering apparatus, and the following film forming process is carried out. As shown in FIG. 8A, an SUL 802 is grown on the substrate 801. Here, the substrate 801 is formed of a tempered glass having a thickness of 0.635 mm, and the SUL is formed of a soft magnetic material containing Co. Although not shown in the drawing, necessary layers such as an adhesion layer are grown between the substrate 801 and the SUL 802. A protective layer 803 is grown on the SUL 802. In this embodiment, Pt having a thickness of 2 nm is used as the protective layer 303, but other materials such as Ta, W, and NiTi may also be used.

Here, the sample is taken out of the vacuum chamber, and a non-magnetic material 804 is grown on the protective layer 803. In forming the non-magnetic material 804, spin-on glass (SOG) is used in place of the sputtering used in the embodiment shown in FIG. 1. The SOG having a photocurable property is spin-coated on the protective layer 803. A coating condition is selected so that the film thickness of the non-magnetic material 804 would be equal to or more than a depth of a later-described uneven structure. In this embodiment, spin-coating is performed at 6000 rpm for three minutes to thereby obtain a film thickness of 80 nm. It should be noted that the film thickness obtained by spin-coating depends on the original viscosity of the SOG, and therefore adjustment is appropriately needed. Moreover, coating may be performed by using methods such as a dispense method and an ink-jet method instead of the spin-coating.

A pattern shape is transferred onto a photocurable SOG layer thus obtained using a mold 805 by an imprinting method as show in FIG. 8B. By this step, a processed non-magnetic uneven structure 806 is obtained. The imprinting by light irradiation is adopted here since the photocurable SOG is used. However, if a material that is thermally deformed is selected, a thermal imprinting method may be used.

In this embodiment, the projected and recessed shapes formed by the imprinting method are used as projected and recessed shapes of the medium. For this reason, a distance between a recording layer to be formed in a next step and a SUL is maintained small, thereby eliminating the base layer removing step explained in connection with FIG. 1. Accordingly, an allowable distance between the recoding layer and the SUL needs to be determined based on the entire configuration including the head, the medium, the drive design, and others. Generally, the shorter the distance between the recoding layer and the SUL is, the better the recording characteristics become. On the other hand, the reproducing characteristics are not generally determined. Therefore, the base layer removing step may be included according to necessity of the drive design. In this embodiment, since a thickness of 5 nm is achieved for a base layer over the entire surface of the disk in the imprinting process, the base layer removing step is omitted. If no base layer removing step is carried out as mentioned above, it is possible to omit or thin the protective layer 803.

Cleaning is carried out as required to remove a foreign matter. Sequentially, as shown in FIG. 8C, a stop layer 807 is grown on the processed non-magnetic uneven structure 806. The following steps are the same as those shown in FIG. 1. That is, FIGS. 8D, 8E, and 8F correspond to FIGS. 1D, 1E and 1F, respectively.

According to this embodiment, it is possible to omit the RIE step for forming the uneven structure performed in the embodiment shown in FIG. 1, thereby producing an effect in reducing media manufacturing cost. It is, of course, possible to obtain the same magnetic recording characteristics as those of the medium manufactured by the method shown in FIG. 1. It should be noted that ion milling and RIE may be additionally performed to control an oblique surface structure of the processed non-magnetic structure 806.

### Explanation of Reference Numerals

101 substrate
102 soft magnetic underlayer
103 protective layer
104 non-magnetic material
105 resist
106 processed non-magnetic structure
107 stop layer
108 seed layer
109 recording layer
110 planarization layer
111 protective film and lubricating film
406 processed non-magnetic structure
408 seed layer
409 recording layer
410 protective film and lubricating film
411 bit
412 servo pattern
601 disk
602 spindle
604 gimbal
605 rotary actuator
606 slider
608 signal processing system
611 substrate
612 soft magnetic underlayer
613 stop layer
614 protective layer
615 seed layer
616 recording layer
617 planarization material
621 recording head
701 substrate
702 soft magnetic underlayer
704 non-magnetic material
705 resist
706 non-magnetic structure
707 stop layer
708 seed layer
709 recording layer
710 planarization material
711 protective film and lubricating film
801 substrate
802 soft magnetic underlayer
803 protective layer
804 non-magnetic material
805 mold
806 non-magnetic structure
807 stop layer
808 seed layer
809 recoding layer

What is claimed is:

1. A perpendicular magnetic recording medium having a magnetic recording layer being magnetically separated for every track or every bit, comprising:
a non-magnetic layer having a recessed portion on at least one surface of a substrate; and
a magnetic recoding layer formed on a bottom surface and a side wall of the recessed portion with a seed layer interposed in between,
wherein the magnetic recording layer is placed in the recessed portion.

2. The perpendicular magnetic recording medium according to claim 1, wherein a stop layer is formed on the non-magnetic layer having the recessed portion.

3. The perpendicular magnetic recording medium according to claim 1, wherein the recessed portion has a soft magnetic underlayer formed under the seed layer.

4. The perpendicular magnetic recording medium according to claim 1, wherein a soft magnetic underlayer is formed under the non-magnetic layer having the recessed portion.

5. The perpendicular magnetic recording medium according to claim 1, wherein a depth of the recessed portion is larger than a thickness obtained by adding thicknesses of the seed layer and the magnetic recording layer.

6. A method for manufacturing a perpendicular magnetic recording medium, comprising the steps of:
forming a soft magnetic underlayer on a substrate;
forming a protective layer on the soft magnetic underlayer;
forming a non-magnetic layer on the protective layer;
forming a recessed portion in the non-magnetic layer;
forming a stop layer on the non-magnetic layer having the recessed portion formed therein;
forming a seed layer on the stop layer;
forming a magnetic recording layer on the seed layer;
forming a non-magnetic planarization layer on the magnetic recording layer; and
performing planarization by removing a layer upper than the stop layer formed on an upper surface of the non-magnetic layer.

7. The method for manufacturing a perpendicular magnetic recording medium according to claim 6, wherein the step of forming the recessed portion in the non-magnetic layer comprises the steps of:
forming a resist pattern on the non-magnetic layer; and
transferring a pattern by using any one of etching and milling, with the resist pattern used as a mask.

8. The method for manufacturing a perpendicular magnetic recording medium according to claim 6, wherein the step of forming the recessed portion in the non-magnetic layer is a step of transferring a pattern onto the non-magnetic layer by using an imprinting method using a mold.

9. The method for manufacturing a perpendicular magnetic recording medium according to claim 6, wherein an etch-back using ion milling is employed in the planarization step.

10. The method for manufacturing a perpendicular magnetic recording medium according to claim 6, wherein chemical-mechanical polishing is employed in the planarization step.

11. A method for manufacturing a perpendicular magnetic recording medium manufacturing method comprising the steps of:
forming a non-magnetic layer on a substrate;
forming a recessed portion in the non-magnetic layer;
forming a stop layer on the non-magnetic layer having the recessed portion;
forming a soft magnetic underlayer on the stop layer;
forming a seed layer on the soft magnetic underlayer;
forming a magnetic recording layer on the seed layer;
forming a non-magnetic planarization layer on the magnetic recording layer; and
performing planarization by removing a layer upper than the stop layer formed on an upper surface of the non-magnetic layer.

12. The method for manufacturing a perpendicular magnetic recording medium according to claim 11, wherein an etch-back using ion milling is employed in the planarization step.

13. The method for manufacturing a perpendicular magnetic recording medium according to claim 11, wherein chemical-mechanical polishing is employed in the planarization step.

14. A magnetic recording apparatus comprising:
a perpendicular magnetic recording medium;
a medium driver that drives the perpendicular magnetic recording medium;
a slider having a perpendicular magnetic recording head and a reproducing head which are mounted on the slider;
a gimbal that fixes the slider;
an actuator that drives the gimbal; and
a signal processing system, wherein
the perpendicular magnetic recording medium includes: a non-magnetic layer having a recessed portion; and a magnetic recoding layer formed on a bottom surface and a side wall of the recessed portion with a seed layer interposed in between,
the magnetic recording layer is placed in the recessed portion, and
the magnetic recording layer is magnetically separated for every track or every bit.

15. The magnetic recording apparatus according to claim 14, wherein a stop layer is formed on the non-magnetic layer having the recessed portion.
